(19) United States
(12) Patent Application Publication
(10) Pub. No.: US 2018/0080367 A1
(43) Pub. Date: Mar. 22, 2018

(54) ENGINE SHIELD

(71) Applicant: Trent Mallett, Loveland, CO (US)

(72) Inventor: Trent Mallett, Loveland, CO (US)

(21) Appl. No.: 15/272,531

(22) Filed: Sep. 22, 2016

(51) Int. Cl. F01P 7/12; B60K 11/08

(52) U.S. Cl. CPC F01P 7/12; B60K 11/085

(57) ABSTRACT

An engine shield that includes: a first side wall; a second side wall; a series of blinds extending between the first side wall and second side wall; a control thermostat on one side wall; and a means move the series of blinds between an open position and a closed position. The engine shield may also include a cover for the first side wall and a cover for the second side wall. Preferably, the engine shield also includes mounting clips, where the mounting clips enable the placement of the engine shield on the inside of a vehicle grill.

### BACKGROUND OF THE INVENTION

### Field of Invention

The present invention relates to an engine shield used to insulate an engine during frigid weather.

### Description of Related Art

Engines must be kept at certain temperatures for optimal operation. During warmer seasons such as spring, summer and fall an engine is not at risk for significant issues with respect to freezing. However it is imperative to keep the engine cool during these seasons. During the winter season the engine stands the risk of freezing and becoming inoperable due to inclement weather. This issue is particularly important with respect to truck engines. Truck engines normally operate on diesel fuel, which has a tendency to gel at lower temperatures. In order to prevent such freeze overs truck operators normally must use products that are seasonal that require frequent removal and installation based upon the weather conditions. As a result, it would be advantageous to have a device that could be installed protect a truck engine during freezing temperatures.

### SUMMARY OF THE INVENTION

The present invention relates to an engine shield that includes: a first side wall; a second side wall; a series of blinds extending between the first side wall and second side wall; a control thermostat on one side wall; and a means move the series of blinds between an open position and a closed position. The engine shield may also include a cover for the first side wall and a cover for the second side wall. Preferably, the engine shield also includes mounting clips, where the mounting clips enable the placement of the engine shield on the inside of a vehicle grill.

### BRIEF DESCRIPTION OF DRAWINGS

FIG. 1 depicts a truck bra in accordance with the present invention.

### DETAILED DESCRIPTION

The present invention relates to a trucking shield or bra that is installed adjacent to a truck's grill. The device is installed permanently behind the grill and left in place year round. The present invention uses a blind type system, where bushings and blinds open and close based upon temperatures. A thermostat and coil are integrated into the operation of the invention and operate based upon the outside temperature. The opening and closure of the blinds of the bra according to the present invention enables the operating temperatures of the vehicle to rise quickly by blocking the influx of outside air across the radiator and engine. This use of this automated bra alleviates the use of a removable bra that requires removal when temperatures rise above 50 degrees Fahrenheit. The use of thermostat control helps to keep the engine warm and operates to cool the engine as needed during warmer months.

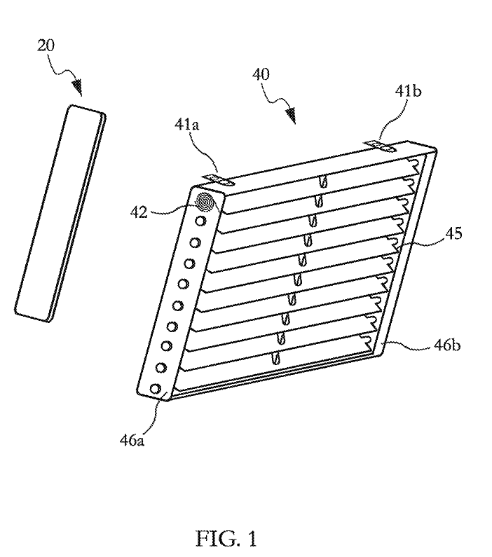

An engine shield 40 according to the present invention is depicted in FIG. 1. The engine shield 40 includes sidewalls 46a, 46b with a series of blinds 45 traversing across main section of the engine shield 40. The blinds 45 are operated based upon a thermostat 42 shown on side panel 46a. When temperatures dipped below a pre-determined temperature the blinds 45 are closed to ensure the engine stays warm or is able to warm up quicker as a result of the blockage of air. Ideally this shield 45 is placed behind the grill as opposed to outside the grill such as a conventional removable bra. Mounting brackets 41a, 41b allow the mounting of the engine shield 40 behind an engine grill. The side walls 46a, 46b are covered with a cover 20 as shown in FIG. 1. During operation these blinds operate in a closed position during cooler or frigid temperatures and then are released into an open position when temperatures rise above a pre-determined temperature. Use of the present invention eliminates the need to utilize a removable bra on a truck vehicle. The instant invention has been shown and described in what it considers to be the most practical and preferred embodiments. It is recognized, however, that departures may be made there from within the scope of the invention and that obvious modifications will occur to a person skilled in the art.

What is claimed is:

1. An engine shield comprising:
a. a first side wall;
b. a second side wall;
c. a series of blinds extending between the first side wall and second side wall;
d. a control thermostat on one side wall; and
e. a means move the series of blinds between an open position and a closed position.

2. The engine shield according to claim 1, further including a cover for the first side wall and a cover for the second side wall.

3. The engine shield according to claim 1, further including mounting clips, where the mounting clips enable the placement of the engine shield on the inside of a vehicle grill.
